(19) United States
(12) Patent Application Publication
(10) Pub. No.: US 2019/0137775 A1
(43) Pub. Date: May 9, 2019

(54) VISION SYSTEM AND FILM VIEWING DEVICE

(71) Applicant: SZ DJI TECHNOLOGY CO., LTD., Shenzhen (CN)

(72) Inventors: Xiaozheng TANG, Shenzhen (CN); Hualiang QIU, Shenzhen (CN); Hao YANG, Shenzhen (CN)

(21) Appl. No.: 16/238,219

(22) Filed: Jan. 2, 2019

Related U.S. Application Data
(63) Continuation of application No. PCT/CN2016/088367, filed on Jul. 4, 2016.

(51) Int. Cl. G02B 27/26; G02B 27/01; H04N 13/332

(52) U.S. Cl. CPC G02B 27/26; G02B 27/0172; G02B 2027/0134; G02B 2027/0123; H04N 13/332

(57) ABSTRACT

A vision system includes two display screens arranged with an acute angle therebetween, a transflective optical component between the two display screens, two polarization optical components, and two optical magnification components coaxial with the two polarization optical components, respectively. Polarization directions of the two polarization optical components are perpendicular to each other. One of the two display screens is parallel to the two polarization optical components, and another one of the two display screens is at a level higher than the two polarization optical components.

### CROSS-REFERENCE TO RELATED APPLICATION

This application is a continuation application of International Application No. PCT/CN2016/088367, filed on Jul. 4, 2016, the entire contents of which are incorporated herein by reference.

### TECHNICAL FIELD

The present disclosure relates to a vision system and, more particularly, to a vision system suitable for a film viewing device and a head-mounted stereo film viewing device including the vision system.

### BACKGROUND

Virtual reality Technology (VRT) is based on hybridizations and combinations of computer graphics, human-computer interface technology, sensor technology, and artificial intelligence technology. New human-computer interaction technology, represented by virtual reality technology, aims to explore natural and harmonious human-computer relationship, making the human-computer interface develop from a perception based mainly on a visual perception to a perception including a plurality of sensory channels, such as vision, audition, tactile sensation, force, smell, kinesthetic sensation, or the like, and develop from manual input to a plurality of effect channel inputs including voice, gestures, attitudes, and line of sight, such that the user can perceive objects in a virtual environment immersively.

The film viewing device is an auxiliary device that can be used to conveniently view enlarged slides. A head-mounted display device is a large-screen portable high-immersion stereoscopic image reality device that is broadly used in various fields.

Three-dimension (3D) technology is used in simulation training, 3D games, telemedicine, and surgery, and is also used to expand the visual capabilities of the human eye by utilizing infrared, microscopy, and electron microscopy devices, etc. The 3D technology can make people experience the impact and shock of stereo vision. Stereo display uses scientific technologies to restore a real three-dimensional world for human beings. Whether a stereo perception is strong is an important indicator for measuring a stereo display device.

In conventional film viewing devices, an aperture stop is ranged after a magnification lens to prevent a user from seeing redundant images and thus to prevent a degraded quality of stereo display. Since the aperture stop limits a size of the incident light beam, the user's field of view is limited. Further, the aperture stop is usually arranged at a focal point of the magnification lens, resulting in a complex structure and a relatively large overall system length, thereby not satisfying the user's need for portability. Although a multifunctional miniaturized electronic display device can be convenient to the user, the “portability” and “miniaturization” limit a size of the display screen, and the smaller display screen can relatively easily cause the user to have eye fatigue.

Certain film viewing device of optical system has a special need for the placement of liquid crystal display, resulting in a relatively complex structure, a relatively large overall system length, and a relatively large volume of optical system.

### SUMMARY

In accordance with the disclosure, there is provided a vision system including two display screens arranged with an acute angle therebetween, a transflective optical component between the two display screens, two polarization optical components, and two optical magnification components coaxial with the two polarization optical components, respectively. Polarization directions of the two polarization optical components are perpendicular to each other. One of the two display screens is parallel to the two polarization optical components, and another one of the two display screens is at a level higher than the two polarization optical components.

Also in accordance with the disclosure, there is provided a film viewing device including a support stand and a vision system arranged at the support stand. The vision system includes two display screens arranged with an acute angle therebetween, a transflective optical component between the two display screens, two polarization optical components, and two optical magnification components coaxial with the two polarization optical components, respectively. Polarization directions of the two polarization optical components are perpendicular to each other. One of the two display screens is parallel to the two polarization optical components, and another one of the two display screens is at a level higher than the two polarization optical components.

### BRIEF DESCRIPTION OF THE DRAWINGS

FIG. 1 is a top view of an exemplary film viewing device consistent with disclosed embodiments of the present disclosure.

FIG. 2 is a side view of an exemplary film viewing device consistent with disclosed embodiments of the present disclosure.

FIG. 3 is a schematic diagram of an exemplary communication consistent with disclosed embodiments of the present disclosure.

Reference numerals used in the drawings include: 100, head-mounted stereo film viewing device; 10, support stand; 11, vision system; 1, first display screen; 2, second display screen; 3, transflective optical component; 4, first polarization optical component; 5, second polarization optical component; 6, first amplification optical component; 7, second amplification optical component; 8 and 9, hole; and 200, electronic device.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

Exemplary embodiments will be described with reference to the accompanying drawings, in which the same numbers refer to the same or similar elements unless otherwise specified.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them. The terms “perpendicular,” “horizontal,” “left,” “right,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe exemplary embodiments, instead of limiting the present disclosure. The term “and/or” used herein includes any suitable combination of one or more related items listed.

Further, in the present disclosure, the disclosed embodiments and the features of the disclosed embodiments may be combined when there are no conflicts.

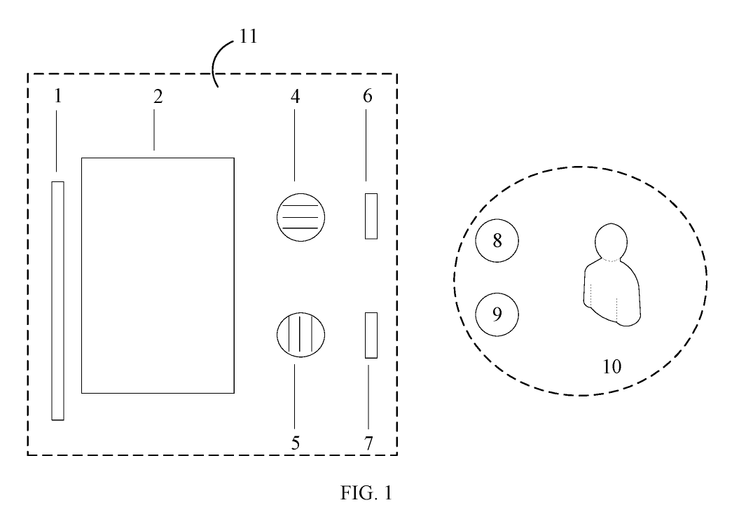

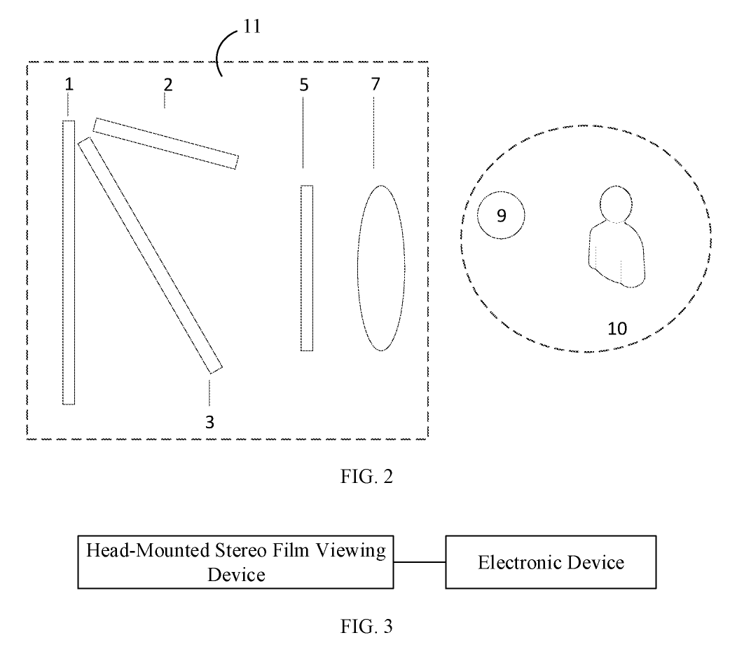

As shown in FIGS. 1 and 2, a head-mounted stereo film viewing device 100 includes a support stand 10 that can be worn on a user's head and a vision system 11 arranged at the support stand 10. The support stand 10 includes a shell. The vision system 11 includes two display screens, e.g., a first display screen 1 and a second display screen 2, a transflective optical component 3, and two polarization optical components, e.g., a first polarization optical component 4 and a second polarization optical component 5, and two optical magnification components, i.e., a first optical magnification component 6 and a second optical magnification component 7.

The two display screens 1 and 2 are arranged at an end that is away from, i.e., distal to, user eyes. The two optical magnification components 6 and 7 are arranged at another end that is near the user eyes, and are symmetrically distributed with the user's nose beam as a center line, corresponding to the user's left and right eyes, respectively. The first polarization optical component 4 and the second polarization optical component 5 are arranged corresponding to the first optical magnification component 6 and the second optical magnification component 7, respectively; and are coaxial with the first optical magnification component 6 and the second optical magnification component 7, respectively. For example, the first polarization optical component 4 is coaxial with the first optical magnification component 6, and the second polarization optical component 5 is coaxial with the second optical magnification component 7. The two polarization optical components 4 and 5 are arranged between the two display screens 1 and 2 and the two optical magnification components 6 and 7. In some embodiments, the first polarization optical component 4 is arranged between the first display screen 1 and the first optical magnification component 6. The second polarization optical component 5 is arranged between the second display screen 2 and the second optical magnification component 7.

The shell can be made of an opaque material. Two holes 8 and 9 are arranged, e.g., opened, at one side of the shell facing the user eyes. The two holes 8 and 9 correspond to the two optical magnification components 6 and 7, respectively; and are blocked by the two optical magnification components 6 and 7. The first display screen 1 and the second display screen 2 are arranged at two adjacent inner side walls of the shell, respectively. For example, the shell can include a first inner side wall and a second inner side wall that are adjacent to each other. The first display screen 1 and the second display screen 2 can be arranged at the first inner side wall and the second inner side wall, respectively.

The first display screen 1 and the second display screen 2 each can include, but is not limited to, a liquid crystal display (LCD), a light-emitting diode (LED) display screen, or an organic light-emitting diode (OLED) display.

The first display screen 1 and the second display screen 2 display left eye image information and right eye image information, respectively. In some embodiments, the first display screen 1 is used to display a right eye image, and the second display screen 2 is used to display a left eye image. In some embodiments, the two display screens may include a horizontal linear polarization screen and a vertical linear polarization screen. The first display screen 1 and the second display screen 2 may be arranged at an acute angle with respect to each other, and the angle between the first display screen 1 and the second display screen 2 may be in a range between approximately 75 degrees and approximately 89 degrees, e.g., approximately 85 degrees. The use of dual display screens with an acute angle therebetween may relatively suppress the restriction on the field-of-view angle and increase a visible range, as compared to the aperture stop that is arranged in a conventional film viewing device to ensure the stereo effect. Further, with an acute angle arrangement, an overall length of the system can be reduced, and the optical system volume can be reduced, as compared to a perpendicular arrangement.

In some embodiments, an overlapping region between the first display screen 1 and the second display screen 2 may exist, to expand the field-of-view angle. An area size of the overlapping region may be determined according to various application scenarios, as long as the stereo imaging performance is not reduced.

The transflective optical component 3 is arranged between the first display screen 1 and the second display screen 2, and one side of the transflective optical component 3 is proximal to an intersection of the first display screen 1 and the second display screen 2. An angle between the transflective optical component 3 and the first display screen 1 can be approximately equal to another angle between the transflective optical component 3 and the second display screen 2. When electric vector E propagates through an interface, direction changes of p light and s light after reflection and/or refraction can be obtained according to the Fresnel formula. Light radiated from the first display screen 1 is refracted by the transflective optical component 3, passes through the second polarization optical component 5, and passes through the first optical magnification component 6 to reach an eye of the user. Light radiated from the second display screen 2 is reflected by the transflective optical component 3, passes through the first polarization optical component 4, and passes through the second optical magnification component 7 to reach another eye of the user.

In some embodiments, the transflective optical component 3 may have a rectangular shape or a trapezoidal shape. In the embodiments that the transflective optical component 3 has a trapezoidal shape, area required can be reduced, coating cost can be reduced, and a volume of optical portion can be reduced to provide relatively large ventilation space.

The first optical magnification component 6 and the second optical magnification component 7 are used for magnifying images. In some embodiments, only one set of magnification lenses may be included, to reduce a phase difference in the image caused by the optical system and make the image relatively real and clear. In some other embodiments, magnification lenses may not be limited to one set of magnification lenses. For example, the magnification lenses may include two sets of magnification lenses or multiple sets of magnification lenses.

The two polarization optical components 4 and 5 are used to form stereo vision. Polarization directions of the two polarization optical components 4 and 5 may be perpendicular to each other. Image signals of the first display screen 1 and the second display screen 2 may have a phase difference after passing through/reflected by the transflective optical component 3, may be modulated by the two polarization optical components 4 and 5, may be magnified by the first and second optical magnification components 6 and 7, and may be projected at the user's retina to form a stereoscopic image.

In some embodiments, the transflective optical component 3 may include a transmissive and reflective flat mirror, such as a flat mirror that can transmit p-polarization and reflect s-polarization or a flat mirror that can reflect p-polarization and transmit s-polarization.

In some embodiments, the head-mounted stereo film viewing device 100 may have a helmet shape, and the support stand 10 for the head-mounted stereo film viewing device of the helmet shape can adjust a degree of tightness according to a size of the user's head. In some embodiments, the head-mounted stereo film viewing device 100 may have the shape of another head-mounted device, such as eyeglasses, and the support stand 10 of the head-mounted stereo film viewing device 100 can be adjusted according to a size of the user's head to adjust a degree of tightness.

In some embodiments, the two optical magnification components 6 and 7 and the two polarization optical components 4 and 5 can be exchanged in positional order. That is, the two polarization optical components 4 and 5 can be arranged closer to the user eyes than the two optical magnification components 6 and 7, and the two optical magnification components 6 and 7 can be arranged between the two polarization optical components 4 and 5 and the two display screens 1 and 2. However, when the two polarization optical components 4 and 5 are closer to the user eyes than the two optical magnification components 6 and 7, light from the two display screens 1 and 2 is irradiated on the two optical magnification components 6 and 7, and the two optical magnification components 6 and 7 may form images at the transflective optical component 3. The images may be seen by the user eyes and may degrade visual effects. In order to suppress the impact, the two optical magnification components 6 and 7 may need to be coated with anti-reflection films, but the coated films may change the a polarization direction of light. In the embodiments that the two polarization optical components 4 and 5 are arranged closer to the user eyes than the two optical magnification components 6 and 7, the needed light cannot be filtered or blocked, thereby disturbing normal viewing. Thus, in some embodiments, the two polarization optical components 4 and 5 are arranged farther away from the user eyes than the two optical magnification components 6 and 7.

As shown in FIG. 3, in some embodiments, the head-mounted stereo film viewing device 100 can further include a peripheral coupling circuit. The peripheral coupling circuit couples the head-mounted stereo film viewing device 100 to an electronic device 200, which has a playback function, through a wired connection or a wireless connection, such that the head-mounted stereo film viewing device can obtain to-be-displayed (TBD) information from the electronic device 200. In some embodiments, for relatively better portability, the head-mounted stereo film viewing device 100 may not carry power by itself, and may be coupled to the electronic device 200 having the playback function through a data line, such that the electronic device 200, as an external device, can send the TBD information to the head-mounted stereo film viewing device 100 and provide power to the dual display screens of the head-mounted stereo film viewing device 100. In some embodiments, the head-mounted stereo film viewing device 100 may have a relatively large volume, and may include a battery compartment to power the head-mounted stereo film viewing device 100 through a battery.

In some embodiments, the head-mounted stereo film viewing device 100 may further include a diopter adjuster (not shown). The diopter adjuster may be arranged closer to the user eyes than the two optical magnification components, e.g., between the shell 10 and the two optical magnification components. The diopter adjuster can adjust diopter within a certain range, such that the user with the diopter within the range can normally use the head-mounted stereo film viewing device 100 without wearing glasses.

In some embodiments, the head-mounted stereoscopic viewer 100 may also include a distance adjustment mechanism. The distance adjustment mechanism may include a gear mechanism for adjusting a distance between two optical components, such as a distance between the two polarization optical components and/or between the two optical magnification components, to accommodate users with different pupil distances.

In some embodiments, the head-mounted stereo film viewing device may include a focal length adjustment mechanism (not shown) for adjusting focal lengths of two optical components, such as focal lengths of the two polarization optical components and/or focal lengths of the two optical magnification components, to match with image qualities of videos with different pixel densities after being magnified by the optical system. In some embodiments, two sets of optical components in the head-mounted stereo film viewing device 100 may be separately coupled to different focal length adjustment mechanisms for adjusting focal lengths of the two sets of optical components separately. In some other embodiments, two sets of optical components may be coupled to one focal length adjustment mechanism for an integrated adjustment. In some embodiments, each set of optical components include two or more optical components, the focal length adjustment mechanism may include a gear adjustment mechanism, and the gear adjustment mechanism may convert rotational motion to linear motion of the optical components, and change the focal length of the optical system by changing the distance between the optical components. In some embodiments, each set of optical component(s) may include only one optical component, and the focal length adjustment mechanism can be used to adjust the focal length if the optical component has a focal length adjustable characteristic. For example, for a liquid lens, the focal length adjustment mechanism may change a shape of liquid for the focal length adjustment by applying a voltage or a mechanical force. Because the focal length adjustment may be relatively professional, the focal length adjustment mechanism can include a gear adjustment, such that an ordinary user can adjust the gear position to ensure the display performance.

In the present disclosure, a transflective optical component and polarization optical components may be used to separate left eye and right eye images to ensure a stereo display effect. Since the aperture stop is not used, constrain on field-of-view may be suppressed as compared to the conventional technologies where the aperture stop is used, and the field-of-view may be increased. Further, there is no need to consider a setting position of the aperture stop, the structure may be relatively simple, the total length of the system may be reduced, satisfying a need for relatively small size and good portability. In addition, the two display screens may be arranged to have an acute angle therebetween, and further reduce the total length of the system, thereby reducing the volume of the vision system and satisfying a need for relatively small size and good portability.

Other embodiments of the disclosure will be apparent to those skilled in the art from consideration of the specification and practice of the embodiments disclosed herein. It is intended that the specification and examples be considered as exemplary only and not to limit the scope of the disclosure, with a true scope and spirit of the invention being indicated by the following claims.

What is claimed is:

1. A vision system comprising:
two display screens arranged with an acute angle therebetween;
a transflective optical component between the two display screens;
two polarization optical components, polarization directions of the two polarization optical components being perpendicular to each other; and
two optical magnification components coaxial with the two polarization optical components, respectively;
wherein one of the two display screens is parallel to the two polarization optical components, and another one of the two display screens is at a level higher than the two polarization optical components.

2. The vision system according to claim 1, wherein the two polarization optical components are arranged between the two display screens and the two optical magnification components.

3. The vision system according to claim 1, wherein the transflective optical component has a trapezoidal shape.

4. The vision system according to claim 1, wherein the two display screens include a horizontal linear polarization screen and a vertical linear polarization screen.

5. The vision system according to claim 1, wherein the vision system is configured to be coupled to an electronic device through a data line to obtain information to be displayed.

6. The vision system according to claim 5, wherein the vision system is further configured to obtain power from the electronic device through the data line.

7. The vision system according to claim 1, wherein the two display screens are arranged with an offset and have an overlapping portion therebetween.

8. The vision system according to claim 1, further comprising:
a distance adjustment mechanism configured to adjust at least one of a first distance between the two polarization optical components or a second distance between the two optical magnification components.

9. The vision system according to claim 1, further comprising:
a focal length adjustment mechanism configured to adjust one or more of focal lengths of the two polarization optical components and focal lengths of the two optical magnification components.

10. The vision system according to claim 1, further comprising:
a diopter adjuster arranged at a side of the two optical magnification components opposite to the two display screens.

11. A film viewing device comprising:
a support stand; and
a vision system arranged at the support stand, including:
two display screens arranged with an acute angle therebetween;
a transflective optical component between the two display screens;
two polarization optical components, polarization directions of the two polarization optical components being perpendicular to each other; and
two optical magnification components coaxial with the two polarization optical components, respectively;
wherein one of the two display screens is parallel to the two polarization optical components, and another one of the two display screens is at a level higher than the two polarization optical components.

12. The film viewing device according to claim 11, wherein:
the film viewing device has a helmet shape; and
the support stand is configured to be adjusted to adjust a degree of tightness.

13. The film viewing device according to claim 11, further comprising:
a shell made of an opaque material and including two holes arranged at locations corresponding to the two optical magnification components, respectively.

14. The film viewing device according to claim 11, wherein the two polarization optical components are arranged between the two display screens and the two optical magnification component.

15. The film viewing device according to claim 11, wherein the visual system is configured to be coupled to an electronic device through a data line to obtain information to be displayed.

16. The film viewing device according to claim 15, wherein the vision system is further configured to obtain power from the electronic device through the data line.

17. The film viewing device according to claim 11, wherein the vision system further includes:
a distance adjustment mechanism configured to adjust at least one of a first distance between the two polarization optical components or a second distance between the two optical magnification components.

18. The film viewing device according to claim 17, wherein the distance adjustment mechanism includes a gear mechanism.

19. The film viewing device according to claim 11, wherein the vision system further includes a focal length adjustment mechanism configured to adjust one or more of focal lengths of the two polarization optical components and focal lengths of the two optical magnification components.

20. The film viewing device according to claim 11, wherein the vision system further includes a diopter adjuster arranged at a side of the two optical magnification components opposite to the two display screens.
